(19) United States
(12) Patent Application Publication
(10) Pub. No.: US 2008/0249947 A1
(43) Pub. Date: Oct. 9, 2008

(54) MULTI-FACTOR AUTHENTICATION USING A ONE TIME PASSWORD

(76) Inventor: Eric R. Potter, Tigard, OR (US)

Correspondence Address: FOLEY & LARDNER LLP, 150 EAST GILMAN STREET, P.O. BOX 1497, MADISON, WI, 53701-1497, US

(21) Appl. No.: 11/697,881

(22) Filed: Apr. 9, 2007

(51) Int. Cl. H04L 9/32

(52) U.S. Cl. 705/67

(57) ABSTRACT

A method of authenticating a user includes receiving a one time password from the user. The received one time password is compared to a first one time password associated with the user and provided to the user on a receipt corresponding to a transaction. The user is authenticated into a service only if the received one time password matches the first one time password associated with the user.

### FIELD

The subject of the disclosure relates generally to a method of providing enhanced information security through multi-factor authentication. More specifically, the disclosure relates to a method of conveniently providing users with one time passwords for use during authentication into a service.

### BACKGROUND

In the information security industry, multi-factor authentication is referred to as ‘strong’ authentication because it significantly decreases an attacker's ability to steal a user's authentication information. Multi-factor authentication can refer to combining two or more authentication techniques together to form a more reliable level of authentication. Authentication techniques generally fall into one of three categories: what a user knows, what a user has, and what a user is. What a user knows refers to a knowledge possessed by the user such as an answer to a question, a username, and/or a password. What a user has refers to a card, one time password generating device, or other object/information which is provided to the user for use during authentication. What a user is refers to the use of biometric information such as a fingerprint to authenticate the user.

In many instances, information security laws, regulations, and internal rules mandate that certain institutions which maintain sensitive customer information (i.e., banks, credit card companies, etc.) utilize a multi-factor authentication technique. Most institutions which implement multi-factor authentication use a knowledge-based authentication technique and either an object/information authentication technique or a biometric authentication technique. For example, to access an automated teller machine (ATM), users are generally required to swipe a card (object) and enter a personal identification number (knowledge). Similarly, to access an online banking or credit card website, users are sometimes required to enter a username and password (knowledge) along with a one time password (provided information) generated by an electronic device in the user's possession.

Unfortunately, traditional multi-factor authentication techniques are limited by excessive costs and implementation difficulties. Biometric devices such as fingerprint readers, voice recognition devices, retina scanners, and facial comparison devices are very expensive to install and maintain, and are generally not an option for users who wish to authenticate from a personal computer. In addition, an enrollment process for biometric authentication is time consuming and requires users to sacrifice their privacy by providing physical identification information. Credit and debit cards which are provided to users must be manufactured and distributed, resulting in costs to the institution or the user. One time password generating devices are expensive, subject to malfunction, and require training such that users can properly utilize them. Other existing methods of one time password distribution are inconvenient and provide users with limited access to obtain the one time passwords.

Thus, there is a need for a multi-factor authentication technique which utilizes one time passwords and is inexpensive, user friendly, and convenient. Further, there is a need for an inexpensive multi-factor authentication technique which can be used for authentication from a personal computer.

### SUMMARY

An exemplary method of authenticating a user includes receiving a one time password from the user. The received one time password is compared to a first one time password associated with the user and provided to the user on a receipt corresponding to a transaction. The user is authenticated into a service only if the received one time password matches the first one time password associated with the user.

Another exemplary method of authenticating a user includes receiving authentication information from the user, wherein the authentication information comprises a one time password. The received one time password is compared to a first one time password associated with the user and provided to the user through an automated teller machine. The user is authenticated into a service only if the received one time password matches the first one time password associated with the user.

An exemplary automated teller machine includes a one time password storage unit capable of storing a one time password. The automated teller machine also includes a printing apparatus, wherein the printing apparatus is capable of printing the one time password such that the one time password can be presented to a user. The automated teller machine also includes a distribution mechanism capable of distributing the printed one time password to the user.

Other principal features and advantages will become apparent to those skilled in the art upon review of the following drawings, the detailed description, and the appended claims.

### BRIEF DESCRIPTION OF THE DRAWINGS

Exemplary embodiments will hereafter be described with reference to the accompanying drawings.

FIG. 1 is a flow diagram illustrating operations performed by an authentication system to distribute one time passwords in accordance with an exemplary embodiment.

FIG. 2 is a receipt including one time passwords in accordance with an exemplary embodiment.

FIG. 3 is a flow diagram illustrating operations performed by the system to authenticate a user with a one time password in accordance with an exemplary embodiment.

FIG. 4 is a user interface for receiving a one time password from a user in accordance with an exemplary embodiment.

FIG. 5 is a block diagram illustrating components of an automated teller machine in accordance with an exemplary embodiment.

### DETAILED DESCRIPTION

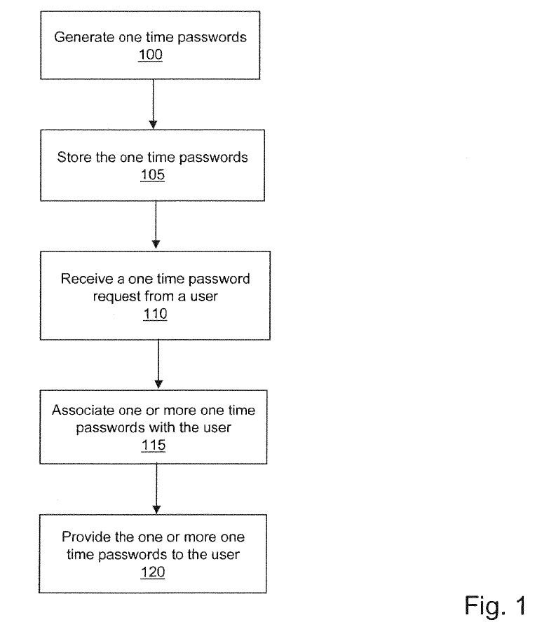

FIG. 1 is a flow diagram illustrating operations performed by an authentication system (or system) to distribute one time passwords in accordance with an exemplary embodiment. Additional, fewer, or different operations may be performed in alternative embodiments. In an exemplary embodiment, the authentication system can be a two-factor authentication system through which a user can authenticate by providing one or more one time passwords and knowledge known to the user such as a password, a username, and/or a response. Alternatively, the user can authenticate through the system by providing one or more one time passwords and knowledge, an object (such as a debit card), and/or biometric information. As described herein, the system is implemented by a financial institution such as a bank. However, this is not meant to be limiting as the system can be implemented by any other institution(s) that wish to provide their customers with secure authentication.

In an operation 100, the system generates one time passwords. A one time password can refer to any password which can be used by a user to authenticate into a service. In an exemplary embodiment, the one time password may only be used a single time by the user such that an electronic theft of the one time password does not provide a thief with future access to the user's account. In addition, the one time password may expire after a predetermined time period has passed. In an exemplary embodiment, the service into which the user authenticates can be a banking service. The user may be asked to provide one or more one time passwords to access the banking service. Alternatively, the user may asked to provide the one or more one time passwords only when the user attempts to perform specific transactions through the banking service. The banking service can be an online banking service, a telephone banking service, an interactive voice response (IVR) banking service, or any other type of banking service. Alternatively, the service can be a credit card service, a bill payment service, or any other service in which the user is able to provide and/or receive sensitive information.

In an exemplary embodiment, the one time passwords generated by the system can be in any form known to those of skill in the art. For example, each of the one time passwords may be six characters in length and may include only numeric characters. Alternatively, each of the one time passwords may be eight characters in length and may include case sensitive alphanumeric characters. Alternatively, a first one time password may include five numeric characters, a second one time password may include seven alphabetical characters, a third one time password may include nine alphanumeric characters, a fourth one time password may include four symbols, and so on. Alternatively, the one time passwords can include any other number of characters and/or can include any combination of letters, numerals, and symbols.

In an operation 105, the system stores the one time passwords. In an exemplary embodiment, the one time passwords can be stored locally in an encrypted data store at a one time password distribution location. For example, the one time passwords can be stored locally at an automated teller machine (ATM) which is capable of distributing the one time passwords to users. Alternatively, the one time passwords can be stored locally at a bank branch which distributes the one time passwords. In an alternative embodiment, the one time passwords can be stored at a central storage location and can be provided to the distribution location at the time of distribution.

In an exemplary embodiment, users can be provided with a plurality of one time passwords at a time such that the user can access the service a plurality of times before obtaining more one time passwords. In one embodiment, the plurality of one time passwords can be stored as a group which can easily be provided to the user. The group can include six, twelve, twenty-four, thirty-six, forty, or any other number of one time passwords. In an alternative embodiment, the system may individually store the one time passwords such that the groups can be formed just prior to distribution of the one time passwords. Alternatively, users may be provided with a single one time password at a time. In another alternative embodiment, the one time passwords may not be generated until a one time password request is received from the user.

In an operation 110, the system receives a one time password request from a user. In an exemplary embodiment, the user can be an existing customer with previously established authentication information. New users may be required to go through an enrollment process as known to those of skill in the art. In another exemplary embodiment, the one time password request can be received through an ATM which includes a one time password request menu option. Prior to making the one time password request, the user may be asked to authenticate into the ATM through a multi-factor authentication process. For example, the user can authenticate into the ATM by entering a personal identification number (PIN) or password, swiping a debit card, and/or by any other method known to those of skill in the art. In an alternative embodiment, the one time password request can be received from the user through an in person communication with a service representative such as a bank teller. The user can provide the service representative with an account number, photo identification, or any other information such that the service representative is able to confidently verify the user's identity.

In an exemplary embodiment, the user can submit a one time password request at any time. For example, the user can submit the one time password request if the user loses his/her one time password(s), if the user's one time password(s) expire, if the user uses all of his/her one time passwords, if the user believes that his/her one time passwords have been stolen, etc. In an alternative embodiment, the user may be provided with one or more new one time passwords each time the user performs a transaction such that the user does not have to submit a one time password request. For example, the user may receive updated one time passwords each time the user uses an ATM and/or each time the user interacts with a bank teller.

In an operation 115, one or more one time passwords are associated with the user. In an exemplary embodiment, the system can associate a group of one time passwords with the user such that the user is not required to obtain new one time passwords each time he/she desires to authenticate into the service. Alternatively, a single one time password may be associated with the user. The one time password(s) can be associated with the user by linking the one time passwords to a user profile corresponding to the user. Alternatively, the one time passwords can be associated with the user by any other method known to those of skill in the art.

In an operation 120, the one or more one time passwords are provided to the user. In an exemplary embodiment, the one or more one time passwords are provided to the user on a receipt corresponding to a transaction. The receipt can be provided to the user through an ATM or other terminal or in person through a service representative. The ATM can be an in branch ATM or any other ATM capable of communicating with the system. The transaction can be a cash withdrawal, a cash deposit, a balance inquiry, a funds transfer, a payment, a purchase, etc. Alternatively, the transaction can simply be a request for the one or more one time passwords.

In an exemplary embodiment, the one or more one time passwords can be printed on the receipt in the form of a grid. Each of the one or more one time passwords on the grid can have a password identifier such that the user can distinguish a first one time password from a second one time password. The receipt can also include a receipt identifier such that the user can distinguish a first receipt from a second receipt. In an alternative embodiment, the one or more one time passwords can be printed on the receipt in the form of a list, a scratch card, or any other form.

In an alternative embodiment, the one or more one time passwords may not be provided to the user on a receipt. For example, the one or more one time passwords can be provided to the user on a grid card, on a scratch card, as a list, or in any other form. The grid card, scratch card, list, or other form can be provided instead of or in addition to a receipt depending on the embodiment. A scratch card can refer to a card which includes a plurality of values, and where the user obtains a one time password by eliminating one or more of the plurality of values. For example, a portion of a scratch card may include the characters 1ty7uiajasfj, and the user may be instructed that his/her one time password is the second, fourth, sixth, and eighth characters in the portion of the scratch card, or t7ij.

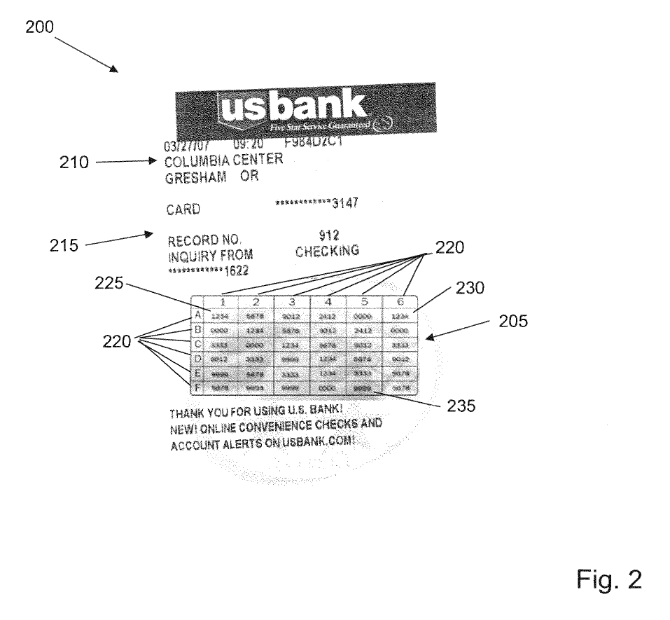

FIG. 2 is a receipt 200 including a grid 205 of one time passwords in accordance with an exemplary embodiment. Grid 205 includes thirty-six one time passwords, each of which are in the form of a four digit numeral. In an alternative embodiment, the one time passwords can be any other length, and can include any combination of letters, numbers, and/or symbols. In another alternative embodiment, grid 205 can include any other number of one time passwords. Grid 205 also includes a plurality of password identifiers 220 such that each of the thirty-six one time passwords can be distinctly identified by the user. For example, a first one time password 225 can be identified as Al, a sixth one time password 230 can be identified as A6, a thirty-fifth one time password 235 can be identified as F5, and so on. In alternative embodiments, any other type of password identifiers can be used.

Receipt 205 also includes a plurality of receipt identifiers 210 and transactional data 215. Receipt identifiers 210 include a date upon which receipt 200 was printed, a time at which receipt 200 was printed, a location at which receipt 200 was printed, a city in which receipt 200 was printed, and a state in which receipt 200 was printed. In alternative embodiments, receipt identifier 210 can include any other identification information such that receipt 200 can be identified and/or distinguished. Transactional data 215 includes information regarding a checking account inquiry transaction. Alternatively, transactional data 215 can be in regard to any other transaction. In another alternative embodiment, receipt 200 may not include transactional data 215.

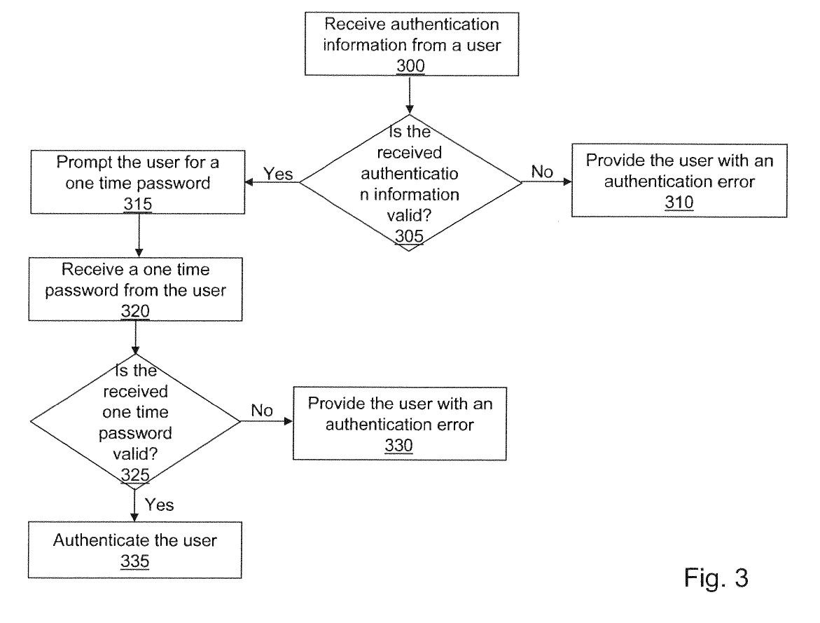

FIG. 3 is a flow diagram illustrating operations performed by the system to authenticate a user with a one time password in accordance with an exemplary embodiment. Additional, fewer, or different operations may be performed in alternative embodiments. In an operation 300, the system receives authentication information from a user. In an exemplary embodiment, the authentication information can be a username, password, question response, or any other knowledge possessed by the user. Alternatively, the authentication information can be any other type of authentication information known to those of skill in the art. In an operation 305, the system determines whether the received authentication information is valid. The system can make the validity determination by any method known to those of skill in the art. If the received authentication information is not valid, the user is provided with an authentication error in an operation 310. The authentication error can be an audio explanation, a textual explanation, a presentation of a blank screen, a reload of an authentication page, or provision of any other indication that the authentication attempt failed.

If the received authentication information is valid, the user is prompted for a one time password in an operation 315. In an exemplary embodiment, the user can be prompted for the one time password prior to being granted any access to the service to which the user is authenticating. Alternatively, the user may be prompted for the one time password only if the user attempts to perform specific operations through the service. For example, the user may be allowed to authenticate into his/her online banking account without providing a one time password, but may be required to provide the one time password prior to transferring funds from one account to another, paying a bill, changing contact information, etc.

In an exemplary embodiment, the system can prompt the user for a plurality of specific one time passwords. For example, the user may have been provided with a grid which includes thirty one time passwords. Each time the user authenticates into the service and/or attempts a specific transaction, the user may be prompted for two one time passwords from the grid. As such, the user can use the grid at least fifteen times before running out of one time passwords. In an alternative embodiment, the system may prompt the user for a single one time password.

In an operation 320, a one time password is received from the user. The user can provide the one time password through a keyboard, through a mouse, through a touch screen, by speech, or by any other method known to those of skill in the art. The system can receive the one time password through a telephone network, through a computing network, etc. by any method known to those of skill in the art. In an operation 325, the system determines whether the received one time password is valid. In an exemplary embodiment, the received one time password can be valid if it matches a one time password which was previously provided to and associated with the user. For example, the user may have been provided with a grid of one time passwords which includes a one time password ‘heV3r3’ at location E6. The user can be prompted for the one time password corresponding to location E6 from the specific grid, and the user can enter ‘heV3r3.’ In an exemplary embodiment, matching the received one time password to a one time password associated with the user can be implemented by any method known to those of skill in the art.

If the system determines that the received one time password is not valid, the system provides the user with an authentication error in operation 330. The authentication error can be the same as the authentication error described with reference to operation 310, or different depending on the embodiment. If the system determines that the received one time password is valid, the system authenticates the user in an operation 335. Once the user is authenticated, the user can access the service, perform one or more transactions, change personal information, etc.

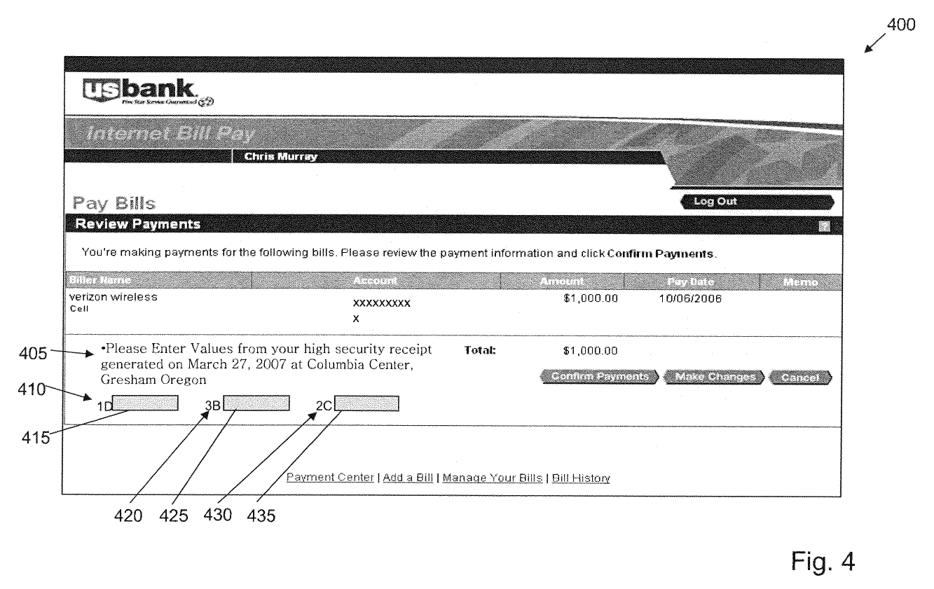

FIG. 4 is a user interface 400 for receiving a one time password from a user in accordance with an exemplary embodiment. User interface 400 illustrates a phone bill payment transaction in which the user is attempting to transfer funds from his bank account to his cellular phone provider. User interface 400 includes a one time password prompt 405 which identifies a source from which the user can obtain the appropriate one time passwords. One time password prompt 405 states “Please Enter Values from your high security receipt generated on Mar. 27, 2007 at Columbia Center, Gresham, Oreg.” Alternatively, one time password prompt 405 can include any other language which identifies the source of the one time passwords. In an alternative embodiment, a one time password prompt may not be used, and the user can be expected to enter one time passwords from his/her most recently received receipt, etc.

User interface 400 also includes a first password identifier 410 corresponding to a first one time password entry box 415, a second password identifier 420 corresponding to a second one time password entry box 425, and a third password identifier 430 corresponding to a third one time password entry box 435. In an exemplary embodiment, the user can use first password identifier 410 to identify a one time password from the receipt referred to by one time password prompt 405. User can enter the identified one time password in first one time password entry box 415. Similarly, the user can identify and enter the appropriate one time passwords in second one time password entry box 425 and third one time password entry box 435. If the user correctly enters all three one time passwords, the system can allow the user to complete the bill payment transaction. If the user enters one or more incorrect one time passwords, the system can provide the user with an error message, prompt the user to reenter the one time passwords, prompt the user to enter different one time passwords, and/or require the user to enter or reenter additional authentication information.

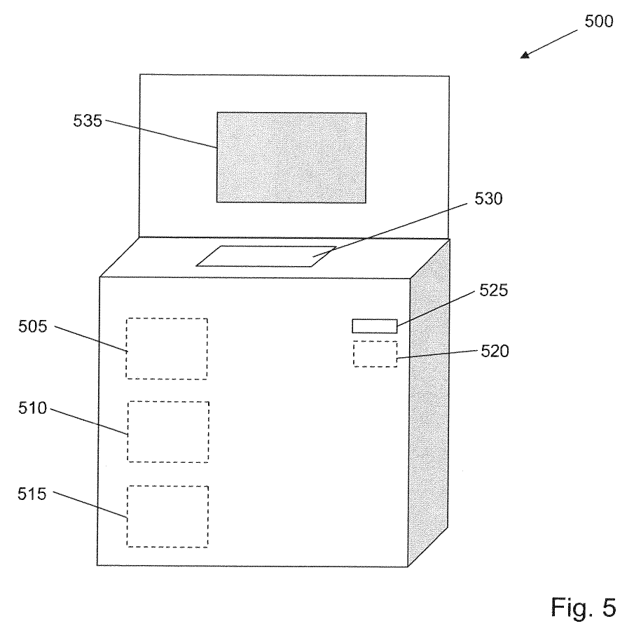

FIG. 5 is a block diagram illustrating components of an automated teller machine 500 in accordance with an exemplary embodiment. Automated teller machine 500 includes a one time password generating unit 505, a one time password storage unit 510, and a communication unit 515. Automated teller machine 500 can use one time password generating unit 505 to generate one time passwords for eventual distribution to a user. In an alternative embodiment, automated teller machine 500 may receive one time passwords from an external source such as a central bank server. One time password storage unit 510 can be capable of storing the generated (or received) one time passwords. In an exemplary embodiment, one time password storage unit 510 can be any type of computer memory known to those of skill in the art. Communication unit 515 can be used to send information to and receive information from an external source such as a central bank server. Communication unit 515 can send authentication information, menu selections, and/or any other information provided by the user to the external source. Communication unit can receive verification information, account information, one time passwords, user profile data, etc. from the external source.

Automated teller machine 500 also includes a printing apparatus 520 and a distribution mechanism 525. Printing apparatus 520 can be used to print the one time password on a receipt, grid card, scratch card, or any other medium such that the one time password can be provided to the user. In an alternative embodiment, the one time password may be pre-printed on a card, receipt, etc. and provided to automated teller machine 500 such that automated teller machine 500 does not print the one time password. Distribution mechanism 525 can be any mechanism capable of distributing the one time password to the user. Automated teller machine 500 also includes an input mechanism 530 and a display 535. Input mechanism 530 can include a debit card reader, a credit card reader, a touch screen, a key board, or any other mechanism through which the user can provide information to automated teller machine 500. Display 535 can be any type of display capable of presenting account information, prompts, and/or menu options to the user.

One or more flow diagrams have been used herein to describe exemplary embodiments. The use of flow diagrams is not meant to be limiting with respect to the order of operations performed. Further, for the purposes of this disclosure and unless otherwise specified, “a” or “an” means “one or more.”

The foregoing description of exemplary embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A method of authenticating a user, the method comprising:
receiving a one time password from a user;
comparing the received one time password to a first one time password associated with the user and provided to the user on a receipt corresponding to a transaction; and
authenticating the user into a service only if the received one time password matches the first one time password associated with the user.

2. The method of claim 1, further comprising providing the first one time password to the user.

3. The method of claim 1, further comprising receiving a one time password request from the user.

4. The method of claim 1, wherein the receipt is provided to the user through an automated teller machine

5. The method of claim 1, wherein the receipt is provided to the user by a service representative.

6. The method of claim 5, wherein the service representative comprises a bank teller.

7. The method of claim 1 wherein the transaction comprises a one time password request.

8. The method of claim 1, wherein the transaction comprises at least one of a money withdrawal, a money deposit, a transfer of funds, and an account balance request.

9. The method of claim 1, wherein the receipt further comprises an identifier corresponding to the first one time password such that the user can distinguish the first one time password from a second one time password on the receipt.

10. The method of claim 1, wherein the receipt further comprises a receipt identifier such that the receipt can be distinguished from a second receipt.

11. A method of authenticating a user comprising:
receiving authentication information from the user, wherein the authentication information comprises a one time password;
comparing the received one time password to a first one time password associated with the user and provided to the user through an automated teller machine; and
authenticating the user into a service only if the received one time password matches the first one time password associated with the user.

12. The method of claim 11, wherein the authentication information further comprises a username and a password.

13. The method of claim 11, wherein the automated teller machine provides the first one time password to the user on a receipt.

14. The method of claim 11, wherein the service comprises an online banking service.

15. The method of claim 11, wherein the service comprises an interactive voice response banking service.

16. An automated teller machine comprising:
a one time password storage unit capable of storing a one time password;
a printing apparatus, wherein the printing apparatus is capable of printing the one time password such that the one time password can be presented to a user; and
a distribution mechanism capable of distributing the printed one time password to the user.

17. The automated teller machine of claim 16, further comprising a one time password generating unit capable of generating the one time password.

18. The automated teller machine of claim 16, wherein the one time password is printed on a receipt.

19. The automated teller machine of claim 16, wherein the one time password is printed on a grid card.

20. The automated teller machine of claim 16, further comprising an input mechanism capable of receiving authentication information from the user.
